(19) United States
(12) Patent Application Publication
(10) Pub. No.: US 2026/0184889 A1
(43) Pub. Date: Jul. 2, 2026

(54) ELASTIC HEAT-RESISTANT COMPOSITION WITH MINIMAL DISCHARGE INCLUDING ALKALI METAL SALTS

(71) Applicant: AGENCY FOR DEFENSE DEVELOPMENT, Daejeon (KR)

(72) Inventors: Jinho HYON, Daejeon (KR); Seung Won KO, Daejeon (KR)

(21) Appl. No.: 19/431,159

(22) Filed: Dec. 23, 2025

(30) Foreign Application Priority Data
Dec. 26, 2024 (KR) 10-2024-0197667

(51) Int. Cl. C08K 5/00; C08K 3/24; C08L 9/00

(52) U.S. Cl. CPC C08K 5/0025; C08K 3/24; C08L 9/00; C08L 2201/08

(57) ABSTRACT

An elastic heat-resistant composition for solid propellant rocket motors is provided, the composition minimizing discharge by including an alkali metal salt.

### CROSS-REFERENCE TO RELATED APPLICATION

This application claims priority to Korean Patent Application No. 10-2024-0197667 filed on Dec. 26, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to an elastic heat-resistant composition for a solid propellant rocket motor, and more particularly to an elastic heat-resistant composition including alkali metal salts that is configured to minimize discharge during motor operation.

### Description of the Related Art

A solid propellant rocket motor for a space launch vehicle generally includes a propellant that generates combustion gases; a combustion chamber, which serves as a structural body; a liner that bonds the propellant to the combustion chamber; an elastic heat-resistant material that protects the combustion chamber from high-temperature gases; and an ignition device that ignites the propellant.

Among these components, the heat-resistant material that protects the combustion chamber is a composite material including a base material, fillers, and/or other additives.

For stable combustion of a solid propellant rocket motor used in space launch vehicles, the erosion rate of the elastic heat-resistant material is a structural factor that significantly affects performance, and thus must be as low as possible.

An elastic heat-resistant material exhibiting high thermal erosion resistance (that is, a low thermal erosion rate) generally improves its erosion characteristics by forming a high-viscosity molten phase and simultaneously generating a strong char layer during combustion.

However, EPDM-based elastic heat-resistant materials developed for this purpose tend to produce hard, large-sized discharge residues when the char layer is ablated and removed, and these residues are expelled through the nozzle.

In rocket motors having a narrow nozzle throat or a pintle, such residues may obstruct the relevant components and lead to performance degradation, presenting an additional problem.

Furthermore, the generation of high-viscosity molten materials and strong char layers may interfere with the normal operation of nozzle components of the solid propellant rocket motor and may cause damage to the components.

Accordingly, the development of clean-burn elastic heat-resistant materials that suppress or eliminate the formation of such components is required.

A clean-burn elastic heat-resistant material must exclude or minimize components that generate high-viscosity molten substances, such as silica (SiO₂), iron oxides (FeO, Fe₂O₃, etc.), and aluminum oxides (Al₂O₃, etc.), and must also minimize the content of heat-resistant fibers (e.g., aramid fibers, carbon fibers, glass fibers, ceramic fibers) that enhance the mechanical strength of the char layer formed on the exposed surface of the elastic heat-resistant material when subjected to high-temperature and high-pressure combustion gases of the solid propellant.

However, when such components that produce high-viscosity molten materials are excluded or minimized and when the content of heat-resistant fibers that increase mechanical strength of the char layer is minimized, it may lead to deterioration of the mechanical and thermal properties of the elastic heat-resistant material or to problems in adhesion and moldability.

Accordingly, the inventors have developed a clean-burn elastic heat-resistant composition (i.e., an elastic heat-resistant composition that minimizes discharge) that excludes components that generate high-viscosity molten materials or residues (such as silica and/or heat-resistant fibers), while maintaining the mechanical properties, thermal properties, adhesion, and moldability required for elastic heat-resistant materials of solid propellant rocket motors, and providing excellent thermal erosion resistance.

### SUMMARY OF THE DISCLOSURE

The purpose of the present disclosure, which aims to solve the aforementioned conventional problems, is to provide an elastic heat-resistant material that exhibits excellent thermal erosion resistance while maintaining the properties required for elastic heat-resistant materials, without including components that generate high-viscosity molten materials or residues, thereby minimizing discharge.

The problems to be solved by the present disclosure are not limited to those mentioned above, and other issues not explicitly stated will be clearly understood by those skilled in the art from the following description.

In order to achieve the purpose, an aspect of the present disclosure provides an elastic heat-resistant composition, comprising: a rubber base material; an additive comprising an alkali metal salt; and a vulcanizing agent.

In some exemplary embodiments, the rubber base material may be one or a combination of two or more selected from the group consisting of nitrile rubber (NBR), natural rubber (NR), styrene-butadiene rubber (SBR), chloroprene rubber (CR), butyl rubber (IR), ethylene-propylene rubber (EPDM), hypalon rubber (CSM), acrylic rubber (ACM/ANM), fluororubber (FPM), silicone rubber (SIU), and butadiene rubber (BR).

In some exemplary embodiments, the ethylene-propylene rubber (EPDM) may be solid ethylene-propylene rubber (EPDM), liquid ethylene-propylene rubber (EPDM), or a combination of solid ethylene-propylene rubber (EPDM) and liquid ethylene-propylene rubber (EPDM).

In some exemplary embodiments, the alkali metal salt may be one or a combination of two or more selected from the group consisting of calcium oxalate, magnesium hydroxide, ammonium sulfate, ammonium benzoate, and magnesium sulfate.

In some exemplary embodiments, the alkali metal salt is present in an amount of 5 to 70 phr based on the rubber base material.

In some exemplary embodiments, the additive may further comprise, as an additional component, one or a combination of two or more selected from the group consisting of oxamide, carbon black, polyimide (PI), polyetheretherketone (PEEK), polytetrafluoroethylene (PTFE), and polybenzimidazole (PBI).

In some exemplary embodiments, the additional component may be present in an amount of 5 to 100 phr based on the rubber base material.

In some exemplary embodiments, the vulcanizing agent may be one or a combination of two or more selected from the group consisting of an ester of saturated fatty acids, zinc oxide (ZnO), stearic acid, RD (2,2,4-trimethyl-1,2-hydroquinoline), DM (dibenzothiazole disulfide), TRA (dipentamethylene thiuram tetrasulfide), sulfur(S), and PVI (N-(cyclohexylthio) phthalimide).

In some exemplary embodiments, the vulcanizing agent may be present in an amount of 0.1 to 30 phr based on the rubber base material.

In addition, another aspect of the present disclosure provides a method for manufacturing an elastic heat-resistant material, using the aforementioned elastic heat-resistant composition.

In some exemplary embodiments, still another aspect of the present disclosure provides an elastic heat-resistant material, comprising the aforementioned elastic heat-resistant composition.

According to an exemplary embodiment of the present disclosure, the elastic heat-resistant composition exhibits the effect of minimizing discharge during the exhaust of combustion gases in solid propellant rocket motors, because the elastic heat-resistant composition of the present disclosure does not include components that produce high-viscosity residues.

Furthermore, according to an exemplary embodiment of the present disclosure, the elastic heat-resistant composition provides the effect of offering an elastic heat-resistant material that maintains the properties required for such materials and exhibits excellent thermal erosion resistance, while not including components that generate high-viscosity residues.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a conceptual diagram illustrating the ASTM E 285-08 test conditions according to an exemplary embodiment of the present disclosure.

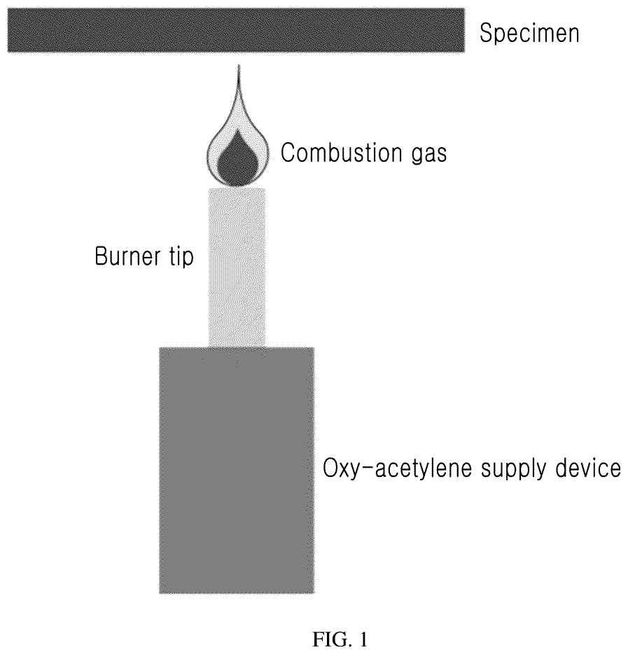

FIG. 2 is a plan view and a front view of a test burner tip for ASTM E 285-08 according to an exemplary embodiment of the present disclosure.

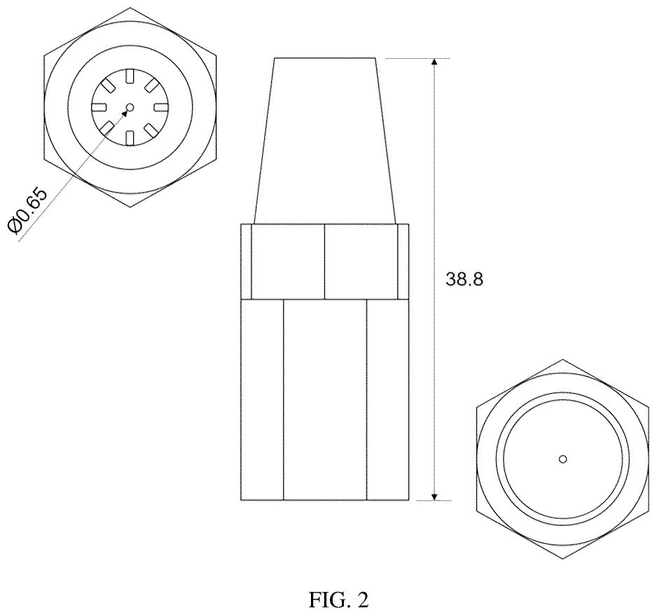

### DETAILED DESCRIPTION OF THE DISCLOSURE

The purpose of the present disclosure is to provide an elastic heat-resistant material that maintains the properties required for such materials and exhibits excellent thermal erosion resistance, while not including components that generate high-viscosity residues so as to minimize discharge.

Hereinafter, exemplary embodiments of the present disclosure will be described in detail with reference to related drawings.

Advantages and features of the present disclosure and methods to implement them will now be described more fully hereinafter with reference to exemplary embodiments accompanied by drawings.

The present disclosure may, however, be embodied in different forms and should not be construed as limited to the exemplary embodiments set forth herein. Rather, these exemplary embodiments are provided so that this disclosure will be thorough and complete, and will fully convey the scope of the present disclosure to those skilled in the art. The scope of the present disclosure shall be defined only by the scope of claims.

When it is determined that a detailed description about known function or structure relating to the present disclosure may evade the main point of the present disclosure, the detailed description may be omitted.

Hereinafter, a detailed description of the present disclosure is provided.

To prevent blockage of the nozzle section caused by combustion of solid propellant rocket motors, coarse particles generated from the decomposition of the elastic heat-resistant material by propellant combustion gases must not be discharged.

For this purpose, the use of additives (or fillers) such as silica (SiO₂), iron oxides (FeO, Fe₂O₃, etc.), and aluminum oxides (Al₂O₃, etc.), and/or heat-resistant fibers such as aramid fibers (for example, Kevlar), carbon fibers, glass fibers, and ceramic fibers, must be excluded or minimized.

However, clean-burn elastic heat-resistant materials having such characteristics exhibit significantly deteriorated thermal erosion characteristics and/or mechanical properties compared to other elastic heat-resistant materials.

In order to solve these problems, the present disclosure provides an elastic heat-resistant composition in which loss of thermal erosion characteristics and/or mechanical properties is minimized, or which exhibits excellent thermal erosion characteristics and/or mechanical properties, by including an organic salt additive (filler) instead of components that generate high-viscosity residues (the above-described additives such as silica, iron oxides, aluminum oxides, and/or heat-resistant fibers).

The present disclosure provides an elastic heat-resistant composition comprising a rubber base material, an additive including an alkali metal salt, and a vulcanizing agent.

In an elastic heat-resistant composition for solid propellants, the base material primarily imparts the mechanical properties required for an elastic heat-resistant material. It is desirable that the base material maintain structural stability even in high-temperature and high-pressure environments and minimize chemical reactions with the propellant. The base material may be an elastomer based on rubber.

The rubber base material may be one or a combination of two or more selected from the group consisting of nitrile rubber (NBR), natural rubber (NR), styrene-butadiene rubber (SBR), chloroprene rubber (CR), butyl rubber (IR), ethylene-propylene rubber (EPDM), hypalon rubber (CSM), acrylic rubber (ACM/ANM), fluororubber (FPM), silicone rubber (SIU), and butadiene rubber (BR).

The rubber base material may include ethylene-propylene rubber (EPDM) or may be ethylene-propylene rubber (EPDM), which may be a synthetic rubber composed mainly of ethylene and propylene.

The ethylene-propylene rubber (EPDM) may include a compound represented by Chemical Formula 1 below.

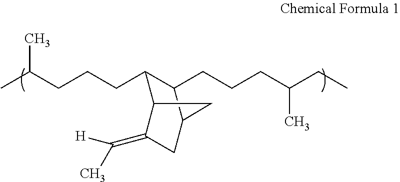

In the EPDM, which is a terpolymer of ethylene, propylene, and ethylidene norbornene (ENB), it is preferable that the ethylene be included in an amount of 50 to 75 wt % based on the total weight of the EPDM, the propylene in an amount of 15 to 48.5 wt %, and the ethylidene norbornene in an amount of 1.5 to 10 wt %. More preferably, the ethylidene norbornene is included in an amount of 5 to 9 wt %.

The ethylene-propylene rubber (EPDM) may be in a solid or liquid form, and may be solid ethylene-propylene rubber (EPDM), liquid ethylene-propylene rubber (EPDM), or a combination of solid EPDM and liquid EPDM. The solid form of EPDM may be in the form of a solid powder, and the solid powder form may be produced by pulverizing high-molecular-weight EPDM rubber into a powder. The liquid form of EPDM may be polymerized to a low molecular weight such that it remains in a liquid state, and may also function as a plasticizer and/or lubricant.

The alkali metal salt may be included in order to compensate for the deterioration in thermal erosion characteristics and/or mechanical properties that occurs when excluding components that generate high-viscosity molten materials (such as silica, iron oxides, and aluminum oxides) and/or heat-resistant fibers (such as aramid fibers, carbon fibers, glass fibers, and ceramic fibers) from conventional elastic heat-resistant compositions for solid propellants that exhibit high thermal erosion performance.

The alkali metal salt may be one or a combination of two or more selected from the group consisting of calcium oxalate, magnesium hydroxide, ammonium sulfate, ammonium benzoate, and magnesium sulfate.

The alkali metal salt may be present in an amount of 5 to 80 phr based on the rubber base material, and preferably 10 to 70 phr or 10 to 50 phr. When the content of the alkali metal salt is below the minimum value or exceeds the maximum value, problems such as deterioration of heat resistance and erosion resistance may occur.

The unit “phr” used in the present disclosure is an abbreviation for “part per hundred rubber,” which means that the component is present at a weight ratio relative to 100 parts of rubber (the rubber base material in the present disclosure) in the rubber composition.

To enhance the heat resistance and/or erosion resistance of the elastic heat-resistant material according to the present disclosure, the additive may further include, as an additional component, one or a combination of two or more selected from the group consisting of oxamide, carbon black, polyimide (PI), polyetheretherketone (PEEK), polytetrafluoroethylene (PTFE), and polybenzimidazole (PBI).

The additional component may be present in an amount of 5 to 100 phr based on the rubber base material, and preferably 10 to 100 phr. When the content of the additional component is outside the above range, heat resistance and/or erosion resistance may be insufficient.

The vulcanizing agent is used for effective vulcanization of rubber (vulcanizing agents or accelerators), and may be one or a combination of two or more selected from the group consisting of an ester of saturated fatty acids, zinc oxide (ZnO), stearic acid, RD (2,2,4-trimethyl-1,2-hydroquinoline), DM (dibenzothiazole disulfide), TRA (dipentamethylene thiuram tetrasulfide), sulfur(S), and PVI (N-(cyclohexylthio) phthalimide).

The vulcanizing agent may be present in an amount of 0.1 to 30 phr based on the rubber base material, and preferably 0.5 to 25 phr. When the content of the vulcanizing agent is below the minimum value, vulcanization may not occur, or significant reduction in vulcanization rate may cause deterioration in processability. When the content exceeds the maximum value, problems related to controlling the vulcanization rate may arise, which may also lead to processability issues.

In addition, the present disclosure provides a method for manufacturing an elastic heat-resistant material using the above-described elastic heat-resistant composition.

The method for manufacturing an elastic heat-resistant material of the present disclosure may be performed by using the above-described elastic heat-resistant composition as a raw material.

Detailed descriptions of the elastic heat-resistant composition are omitted herein to avoid redundancy.

Specifically, the method for manufacturing an elastic heat-resistant material of the present disclosure may be performed by including a mixing step and a vulcanization step using the above-described elastic heat-resistant composition.

The method may also be performed by including a mixing step, an extrusion/forming step, and a vulcanization step.

However, the method for manufacturing an elastic heat-resistant material according to the present disclosure is not limited as long as it uses the above elastic heat-resistant composition, and may be performed using conventional methods known in the technical field of the present disclosure.

Furthermore, the present disclosure provides an elastic heat-resistant material comprising the above-described elastic heat-resistant composition.

The elastic heat-resistant material of the present disclosure may include the above-described elastic heat-resistant composition as a raw material.

The elastic heat-resistant material may also be manufactured by the above-described elastic heat-resistant composition and the above-described method for manufacturing an elastic heat-resistant materials.

Detailed descriptions of the elastic heat-resistant composition are omitted herein to avoid redundancy.

However, the elastic heat-resistant material according to the present disclosure is not limited as long as it includes the above-described elastic heat-resistant composition, and may follow conventional manufacturing methods, forms, or uses known in the technical field of the present disclosure.

Hereinafter, exemplary embodiments are presented to aid in the understanding of the present disclosure; however, the following embodiments are merely illustrative and are not intended to limit the scope of the present disclosure.

### EXAMPLES AND COMPARATIVE EXAMPLES

A rectangular test specimen was prepared by compounding the mixture according to the compositions shown in Table 1, mixing the compounded materials through roll mixing milling, and vulcanizing the mixture (vulcanization at 160° C. for 60 minutes). The following experiments were then performed on the resulting specimen.

TABLE 1

| | | Composition (phr) | | | | | |
|---|---|---|---|---|---|---|---|
| | | Comparative | Comparative | | | | |
| | Component | Example 1 | Example 2 | Example 1 | Example 2 | Example 3 | Example 4 |
| Base | EPDM | 80 | 80 | 80 | 80 | 80 | 80 |
| Material | liquid EPDM | 20 | 20 | 20 | 20 | 20 | 20 |
| Additive | magnesium | 2 | | 5 | 20 | 20 | 30 |
| | hydroxide | | | | | | |
| | ammonium sulfate | 3 | | 10 | | 30 | |
| | magnesium sulfate | | 2 | | 20 | | |
| | Ammonium | | 3 | | | | 20 |
| | benzoate | | | | | | |
| | Calcium oxalate | | | | | | 20 |
| | oxamide | 50 | 50 | 50 | 50 | 50 | 50 |
| | carbon black | 30 | 30 | 30 | 30 | 30 | 30 |
| Vulcanizing | dioctyl adipate | 5 | 5 | 5 | 5 | 5 | 5 |
| Agent | ester of saturated | 2 | 2 | 2 | 2 | 2 | 2 |
| | fatty acids | | | | | | |
| | ZnO | 5 | 5 | 5 | 5 | 5 | 5 |
| | stearic acid | 1 | 1 | 1 | 1 | 1 | 1 |
| | 2,2,4-trimethyl- | 2 | 2 | 2 | 2 | 2 | 2 |
| | 1,2-hydroquinolin | | | | | | |
| | dibenzothiazole | 1.25 | 1.25 | 1.25 | 1.25 | 1.25 | 1.25 |
| | disulfide | | | | | | |
| | dipentamethylene | 0.75 | 0.75 | 0.75 | 0.75 | 0.75 | 0.75 |
| | thiuram | | | | | | |
| | tetrasulfide | | | | | | |
| | S | 1 | 1 | 1 | 1 | 1 | 1 |
| | N-(cyclohexyl | 0.2 | 0.2 | 0.2 | 0.2 | 0.2 | 0.2 |
| | thio) phthalimide | | | | | | |

### Experimental Example 1

To evaluate thermal erosion performance, an oxygen/acetylene torch combustion test (O/A Torch) for elastic heat-resistant materials was performed on the prepared specimens in accordance with ASTM E 285-08, which is applied to internal testing of solid propellant rocket motors. The results are shown in Table 2.

Specifically, under the ASTM E 285-08 test conditions, the burn-through time (sec) was measured for specimens having a thickness of 6 mm to 8 mm, and the oxygen/acetylene flow rates were controlled such that the oxygen was maintained at 3.0 kgf/m² and the acetylene at 0.5 kgf/m² in terms of pressure. The burner tip was designed to achieve these flow conditions.

TABLE 2

| | Comparative | Comparative | | | | |
|---|---|---|---|---|---|---|
| | Example 1 | Example 2 | Example 1 | Example 2 | Example 3 | Example 4 |
| Erosion | 0.650~0.700 | 0.650~0.700 | 0.500~0.550 | 0.450~0.500 | 0.380~0.450 | 0.550~0.600 |
| Rate | | | | | | |
| (mm/s) | | | | | | |

According to Table 2, even when alkali metal salts were used instead of fillers such as silica and heat-resistant fibers, it was confirmed that discharge during combustion gas exhaust was minimized by not including such fillers, and that the thermal erosion rate was sufficiently low.

Although performance requirements vary depending on the propulsion system, the results indicate that the compositions of the present disclosure sufficiently meet the range applicable to current systems.

### Experimental Example 2

To confirm whether the developed compositions meet the general property requirements for elastic heat-resistant materials, tensile strength, elongation, and hardness tests were performed in a temperature range of −40° C. to 60° C. according to the KS M 6518 test method for vulcanized rubber (test temperatures: −40° C./0° C./20° C./60° C.). The results are shown in Table 3 below.

TABLE 3

| | Standard | Comparative | Comparative | | | | |
|---|---|---|---|---|---|---|---|
| | Value | Example 1 | Example 2 | Example 1 | Example 2 | Example 3 | Example 4 |
| Tensile | 50 or | 60-80 | 60-80 | 60-80 | 60-80 | 60-80 | 60-80 |
| strength | more | | | | | | |
| (kg/cm²) | | | | | | | |
| Elongation | 50 or | 300-400 | 300-400 | 300-400 | 300-400 | 300-400 | 300-400 |
| (%) | more | | | | | | |
| Hardness | 60 or | 70-75 | 70-75 | 70-75 | 70-75 | 70-75 | 70-75 |
| (Shore-A) | more | | | | | | |

According to Table 3, even when alkali metal salts were used instead of fillers such as silica and heat-resistant fibers, the omission of such fillers minimized discharge during combustion gas exhaust, while the tensile strength, elongation, and hardness all satisfied the standard values required for elastic heat-resistant materials.

In the above, specific exemplary embodiments of the elastic heat-resistant composition with minimal discharge including alkali metal salts according to the present disclosure have been described. However, it will be apparent that various modifications can be made without departing from the scope of the present disclosure.

Therefore, the scope of the present disclosure should not be limited to the described exemplary embodiments, but should be defined by the following claims and their equivalents.

That is, the foregoing embodiments are illustrative in all aspects and not limiting, and the scope of the present disclosure should be indicated by the claims described below rather than the detailed description. All modifications and variations derived from the meaning, scope, and equivalent concepts of the claims should be construed as being included within the scope of the present disclosure.

The elastic heat-resistant composition of the present disclosure provides the effect of minimizing discharge during the exhaust of combustion gases in solid propellant rocket motors by not including components that generate high-viscosity residues.

In addition, the elastic heat-resistant composition of the present disclosure provides the effect of offering an elastic heat-resistant material that maintains the properties required for such materials and exhibits excellent thermal erosion resistance, while not including components that generate high-viscosity residues.

What is claimed is:

1. A clean-burn elastic heat-resistant composition, comprising:
a rubber base material;
an additive comprising an alkali metal salt; and
a vulcanizing agent,
wherein the alkali metal salt is one or a combination of two or more selected from the group consisting of calcium oxalate, magnesium hydroxide, ammonium sulfate, ammonium benzoate, and magnesium sulfate,
wherein the alkali metal salt is present in an amount of 15 to 70 phr based on the rubber base material,
wherein the vulcanizing agent is selected entirely from the group consisting of an ester of saturated fatty acids, zinc oxide (ZnO), stearic acid, RD (2,2,4-trimethyl-1,2-hydroquinoline), DM (dibenzothiazole disulfide), TRA (dipentamethylene thiuram tetrasulfide), sulfur(S), and PVI (N-(cyclohexylthio) phthalimide), and
wherein the clean-burn elastic heat-resistant composition is used to suppress nozzle blockage and suppress damage to a combustion chamber of a solid propellant rocket motor for a space launch vehicle.

2. The clean-burn elastic heat-resistant composition of claim 1,
wherein the rubber base material is one or a combination of two or more selected from the group consisting of nitrile rubber (NBR), natural rubber (NR), styrene-butadiene rubber (SBR), chloroprene rubber (CR), butyl rubber (IR), ethylene-propylene rubber (EPDM), hypalon rubber (CSM), acrylic rubber (ACM/ANM), fluororubber (FPM), silicone rubber (SIU), and butadiene rubber (BR).

3. The clean-burn elastic heat-resistant composition of claim 2,
wherein the ethylene-propylene rubber (EPDM) is solid ethylene-propylene rubber (EPDM), liquid ethylene-propylene rubber (EPDM), or a combination of solid ethylene-propylene rubber (EPDM) and liquid ethylene-propylene rubber (EPDM).

4. The clean-burn elastic heat-resistant composition of claim 1,
wherein the additive further comprises, as an additional component, one or a combination of two or more selected from the group consisting of oxamide, carbon black, polyimide (PI), polyetheretherketone (PEEK), polytetrafluoroethylene (PTFE), and polybenzimidazole (PBI).

5. The clean-burn elastic heat-resistant composition of claim 4,
wherein the additional component is present in an amount of 5 to 100 phr based on the rubber base material.

6. The clean-burn elastic heat-resistant composition of claim 1,
wherein the vulcanizing agent is present in an amount of 0.1 to 30 phr based on the rubber base material.

7. A method for manufacturing a clean-burn elastic heat-resistant material,
using the composition of claim 1.

8. A clean-burn elastic heat-resistant material, comprising the composition of claim 1.
